(19) United States
(12) Patent Application Publication
(10) Pub. No.: US 2024/0334124 A1
(43) Pub. Date: Oct. 3, 2024

(54) METHOD FOR LOCATING A SOUND SOURCE

(71) Applicant: DAIMLER TRUCK AG, Leinfelden-Echterdingen (DE)

(72) Inventors: Sebastian DINGLER, Leinfelden-Echterdingen (DE); Philipp MITTMANN, Leinfelden-Echterdingen (DE); Margarita KUNJAVSKAJA, Leinfelden-Echterdingen (DE); Zhiliang ZHOU, Leinfelden-Echterdingen (DE)

(21) Appl. No.: 18/622,894

(22) Filed: Mar. 30, 2024

(30) Foreign Application Priority Data
Mar. 30, 2023 (DE) 10 2023 108 153.5

(51) Int. Cl. H04R 3/00; B62D 15/02; H04R 1/40

(52) U.S. Cl. CPC H04R 3/005; H04R 1/406; B62D 15/0265; H04R 2201/401; H04R 2499/13

(57) ABSTRACT

A sound source is located by recording a sound generated by the sound source by several microphones arranged on a vehicle. A direction or position of the sound source is determined relative to the vehicle using a delay in the reception of the sound at one of the microphones in relation to another of the microphones.

### CROSS-REFERENCE TO RELATED APPLICATIONS

This application claims priority under 35 U.S.C. § 119 to German Patent Application No. 10 2023 108 153.5, filed Mar. 30, 2023, the entire disclosure of which is herein expressly incorporated by reference.

### BACKGROUND AND SUMMARY OF THE INVENTION

Exemplary embodiments of the invention relate to a method for locating a sound source and to a vehicle for locating a sound source.

In the future, automated vehicles (including HGVs, passenger cars, buses, . . . ) will travel on the roads without drivers. Accordingly, automated driving systems must take over the tasks of human drivers. These include recognizing and locating two-wheeled vehicles, in particular motorbikes.

WO 2020/259892 A1 describes a method for generating a model of the environment of an automated vehicle. In the method, sensor data is recorded by a plurality of infrastructure-side sensors in a region surrounding the vehicle. Merged sensor data is generated stationarily based on the recorded sensor data. Environment model data is further generated stationarily by infrastructure-side evaluation of the sensor data, wherein objects situated in the surrounding region are located and identified. The environment model data is finally transmitted to the vehicle. A method for autonomously controlling a vehicle is additionally described. An environment model generation apparatus and a vehicle control apparatus are additionally described. An autonomous vehicle and an automated transport system are further described. A junction in the road network has a core region with high priority and a peripheral region with lower priority. The junction is monitored using sensor units. Two vehicles, which are respectively driving towards the junction, are located in the region of the junction, and thus also in the monitoring region. A motorbike is furthermore detected, which is moving away from the inner monitoring region. Furthermore, a person who is crossing a zebra crossing is detected in the inner monitoring region. Monitoring data is transmitted by radio from a communication unit to vehicles located in the transmission range. Sensor data recorded in the vehicle about the region surrounding the vehicle is also used to generate the environment model data. A database for the environment model of the vehicle can be expanded, so that the reliability, resolution, and completeness of the environment model are improved.

Exemplary embodiments the invention are directed to a novel method for locating a sound source and a novel vehicle.

In a method for locating a sound source, a sound generated by the sound source is recorded by several microphones arranged on a vehicle. According to the invention, a direction and/or position of the sound source is determined relative to the vehicle using a delay in the reception of the sound at one of the microphones in relation to another of the microphones.

In one embodiment, the direction and/or position is checked and/or corrected taking into account a world model, which is created using data recorded by means of an environment sensor system of the vehicle and/or map information from a digital map and which contains information about objects on which the sound is reflected.

In one embodiment, a motorized two-wheeled vehicle is located as a sound source. A motorized two-wheeled vehicle can, for example, be differentiated from other sound sources using characteristic motor noises.

In one embodiment, a driving behavior of the vehicle is adapted to the direction and/or position of the sound source. For example, the vehicle can be steered in a transverse direction in order to avoid an expected two-wheeled vehicle. As an alternative or in addition, an indication or a warning that a two-wheeled vehicle is approaching, and where it is located, can be transmitted to a driver of the vehicle.

According to one aspect of the present invention, a vehicle comprising several microphones and a control device is disclosed, which control device is configured to carry out the method described above.

In one embodiment, the vehicle is designed as a commercial vehicle, as a passenger car or as a bus.

In one embodiment, the vehicle is configured as an automated or highly automated, in particular autonomous vehicle.

In one embodiment, at least four microphones are provided on the vehicle.

In one embodiment, two microphones each are arranged on a left side and on a right side of a cabin of the vehicle.

Locating two-wheeled vehicles is challenging, because they are agile and smaller than other vehicles. The present invention makes it possible to locate two-wheeled vehicles more precisely, because sound reflections, which arise due to obstructions, can be taken into account.

Exemplary embodiments of the invention are explained in more detail in the following with reference to the drawings.

### BRIEF DESCRIPTION OF THE DRAWING FIGURES

Here:

FIG. 1 shows a schematic view of a vehicle,

FIG. 2 shows a schematic view of a processing chain, in which a sound source can be located using sound signals and a world model, and

FIG. 3 shows a schematic view of a traffic situation, in which a sound source cannot be directly located by a control unit of the vehicle due to occlusion and/or reflection by other objects.

Parts corresponding to one another are provided with the same reference numerals in all figures.

### DETAILED DESCRIPTION

In a traffic jam or in slow-moving traffic, it is often the case that two-wheeled vehicles, in particular motorbikes, weave between the vehicles and move through the traffic at a higher relative speed. Because the two-wheeled vehicles drive between the vehicles, they can be difficult to recognize (e.g., blind spot) and are seen relatively late (e.g., occlusions). Visual perception is thus more difficult. An acoustic perception, however, is often possible earlier due to the characteristic motor noise of two-wheeled vehicles. Although exact locating may not be possible, the behavior of the vehicle can at least be adapted, for example in order to make a lateral change in position in order to make it easier for the two-wheeled vehicle to pass, so that no dangerous situations can arise. The invention is thus concerned with an acoustic method for recognizing and locating two-wheeled vehicles with a motor.

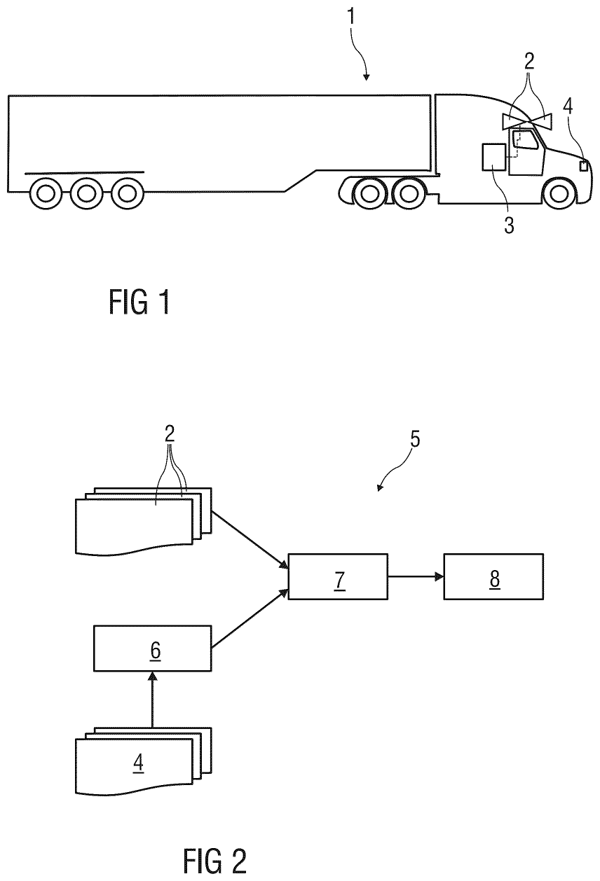

FIG. 1 is a schematic view of a vehicle 1, for example of a commercial vehicle.

Several microphones 2 are attached to the vehicle 1. For example, at least four microphones 2 can be used, in particular two microphones 2 each on a left side and on a right side of a cabin of the vehicle 1. The vehicle 1 has a control device 3, in which signals of the microphones 2 are processed by a piece of software.

The software additionally has access to a world model 6 (depicted in FIG. 2), which is created using data recorded by an environment sensor system 4 of the vehicle 1 and map information from a digital map. The world model 6 contains knowledge about an environment surrounding the vehicle 1, for example the positions of other vehicles and information about the road, for example whether the vehicle 1 is in a tunnel, or other structural information.

The environment sensor system 4 can, for example, have at least one camera, at least one lidar sensor, and/or at least one radar sensor.

The direction of the sound can be determined by measuring a difference in an incidence of a sound signal between at least two microphones 2. The exact direction cannot always be derived from this, for example if the sound comes from a direction other than the source of the sound due to occlusions and reflections.

By using the world model 6, the sound reflections can be taken into account, i.e., a direction estimation can be corrected, because the sound direction of the signal received by the microphone 2 lies on a reflective surface.

FIG. 2 is a schematic view of a processing chain 5, in which more precise sound locating 7 can be implemented using the sound signals and the world model 6, on the basis of which sound locating the driving behavior 8 of the vehicle 1 can be adapted.

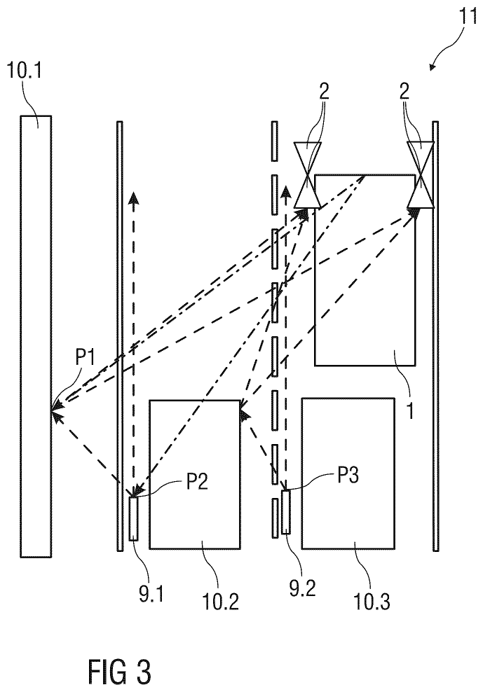

FIG. 3 is a schematic view of a traffic situation 11, in which, due to occlusion and/or reflection by other objects 10.1, 10.2, 10.3, a sound source 9.1, 9.2, for example a motorized two-wheeled vehicle 9.1, 9.2, cannot be directly located by the control device 3 of the vehicle 1. In the depicted example, the sound is reflected by an object 10.1 in the form of a wall and/or by an object 10.2 in the form of another vehicle, and occluded by two objects 10.2, 10.3 in the form of other vehicles. The particular direction of the sound can be corrected by the world model 6, and thus by knowing of the existence of the wall, its position and alignment. The control device 3 would locate the sound source 9.1 at a position P1 without taking the world model 6 into account, using the sound received by the microphones 2. Knowing the wall as an object 10.1 from the world model 6, however, the control device 3 locates the sound source 9.1 at a position P2 using the sound received by the microphones 2. Furthermore, knowing the other vehicle as an object 10.2 from the world model 6, the control device 3 locates the sound source 9.1 at a position P3 using the sound received by the microphones 2.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 vehicle
2 microphone
3 control device
4 environment sensor system
5 processing chain
6 world model
7 sound locating
8 driving behavior
9.1, 9.2 sound source, two-wheeled vehicle
10.1 to 10.3 object
11 traffic situation
P1 to P3 position

What is claimed is:

1. A method comprising:
receiving and recording, by a plurality of microphones arranged on a vehicle, a sound generated by a sound source;
determining a direction or position of the sound source relative to the vehicle using a delay in reception of the sound at one of the plurality of microphones relative to another of the plurality of microphones.

2. The method of claim 1, further comprising:
checking or correcting the determined direction or position taking into account a world model created using data recorded by an environment sensor system of the vehicle or map information from a digital map and which contains information about objects on which the sound is reflected.

3. The method of claim 1, wherein the sound source is a motorized two-wheeled vehicle is located as a sound source.

4. The method of claim 1, further comprising:
adapting a driving behavior of the vehicle based on the determined direction or position of the sound source.

5. A vehicle comprising:
a plurality of microphones configured to receive and record a sound generated by a sound source; and
a controller coupled to the plurality of microphones and configured to determine a direction or position of the sound source relative to the vehicle using a delay in reception of the sound at one of the plurality of microphones relative to another of the plurality of microphones.

6. The vehicle of claim 5, wherein the vehicle is a commercial vehicle, passenger car, or a bus.

7. The vehicle of claim 5, wherein the vehicle is an automated or highly automated vehicle.

8. The vehicle of claim 5, wherein the plurality of microphones include at least four microphones.

9. The vehicle of claim 8, wherein a first two of the at least four microphones are arranged on a left side of a cabin of the vehicle and a second two of the at least four microphones are arranged on a right side of the cabin of the vehicle.
